(19) United States
(12) Patent Application Publication
(10) Pub. No.: US 2011/0235106 A1
(43) Pub. Date: Sep. 29, 2011

(54) INFORMATION PROCESSING APPARATUS, INFORMATION PROCESSING METHOD, AND STORAGE MEDIUM

(75) Inventor: Ryutaro Watanabe, Tokyo (JP)

(73) Assignee: CANON KABUSHIKI KAISHA, Tokyo (JP)

(21) Appl. No.: 13/033,811

(22) Filed: Feb. 24, 2011

(30) Foreign Application Priority Data
Mar. 23, 2010 (JP) 2010-065944

(51) Int. Cl. G06F 3/12

(52) U.S. Cl. 358/1.15

(57) ABSTRACT

When a user accesses a server from an image forming apparatus for document printing, it is ensured that the user can operate on a print operation screen corresponding to a portlet without involving significant labor. An image forming apparatus 1004 is managed by a printer portlet server 1003, and the server 1003 is connected to a portlet server 1002 via a portal server 1001. The portal server 1001 searches the portlet, which is associated with the image forming apparatus 1004 that have given a print instruction, based on the association information between the portlet and the image forming apparatus. When the portlet server 1002 has an UI for printing (user interface) suited for the portlet, the portal server 1001 transmits data, which is used for generating an operation screen for the UI for printing according to the searched portlet, to the image forming apparatus 1004, and then the image forming apparatus 1004 displays the operation screen.

### BACKGROUND OF THE INVENTION

1. Field of the Invention

The present invention relates to a technique for providing data for generating a print operation screen corresponding to an application in accordance with a request from an image forming apparatus.

2. Description of the Related Art

In recent years, software has been rapidly shifted towards Web-based application due to technical improvement and ease of maintenance of the Web, whereby a user can utilize software resources from various types of apparatuses that can be connected to a network. With the enhanced performance of image forming apparatuses, there are also emerging image forming apparatuses that include a Web browser and can directly access to the Web system on the network. However, many of the Web systems, which assume use mainly from a personal computer, are difficult to use from image forming apparatuses that have insufficient user interface functions.

Hence, as a conventional technique, Japanese Patent Laid-Open No. 2007-312166 discloses a technique in which access permission for applications used from an image forming apparatus is set for each user to thereby display only the permitted applications. With this arrangement, an application malfunction may be prevented, resulting in an increase in the operability thereof.

However, in the conventional technique, control is only made on the basis of individual applications, whereby the operability of each application cannot be improved. For example, when a user wishes to print a document managed by an application from an image forming apparatus, a target document needs to be searched by tracing a folder hierarchy as in the case where an access is made from a personal computer, resulting in a considerable increase in time and labor.

In view of the foregoing, the present invention provides a technique in which operation can be made on a print operation screen corresponding to an application that does not involve significant labor, when a user accesses a server from an image forming apparatus to thereby print a document.

### SUMMARY OF THE INVENTION

In view of the foregoing, according to an aspect of the present invention, an information processing apparatus that transmits data for generating a print operation screen according to an application to an image forming apparatus in accordance with a document print instruction given by the image forming apparatus is provided that includes a determination unit configured to determine an application associated with the image forming apparatus that has given a document print instruction and a user who has given the print instruction; a specification unit configured to specify document data to which printing has been ordered by the user in document data associated with the application determined by the determination unit; and a control unit configured to control transmission of data for generating a print operation screen according to the application determined by the determination unit to the image forming apparatus such that information relating to document data specified by the specification unit is displayed and information relating to document data not specified by the specification unit is not displayed.

According to the present invention, the operational load can be reduced when a user specifies a desired document using an image forming apparatus to carry out printing.

Further features of the present invention will become apparent from the following description of exemplary embodiments with reference to the attached drawings.

### BRIEF DESCRIPTION OF THE DRAWINGS

FIG. 1 is a diagram illustrating an exemplary system configuration in order to explain one embodiment of the present invention in conjunction with FIGS. 2 to 4.

FIG. 2 is a diagram illustrating an example of the configuration of a portal server.

FIG. 3 is a diagram illustrating an example of the configuration of a portlet server.

FIG. 4 is a diagram illustrating an example of the configuration of a printer portlet server.

FIG. 5A is a diagram illustrating an example of the screen configuration of a portal system.

FIG. 5B is a diagram illustrating an example of the screen configuration of an application portlet.

FIG. 6A is a diagram illustrating an example of the screen configuration of a printer portlet.

FIG. 6B is a diagram illustrating display and selection operation of FIG. 6A.

FIG. 7A is a diagram illustrating an example of the screen configuration of a file management portlet.

FIG. 7B is a diagram illustrating display and selection operation of FIG. 7A.

FIG. 8 is a flowchart illustrating an example of processing.

FIG. 9 is a flowchart illustrating an example of generation processing for a print screen.

FIG. 10 is a diagram illustrating an example of the print operation screen of the portal system when an access is made from an image forming apparatus.

FIG. 11A is a diagram illustrating an example of the print operation screen of the application portlet when an access is made from an image forming apparatus.

FIG. 11B is a diagram illustrating another example of the print operation screen of the application portlet when an access is made from an image forming apparatus.

### DESCRIPTION OF THE EMBODIMENTS

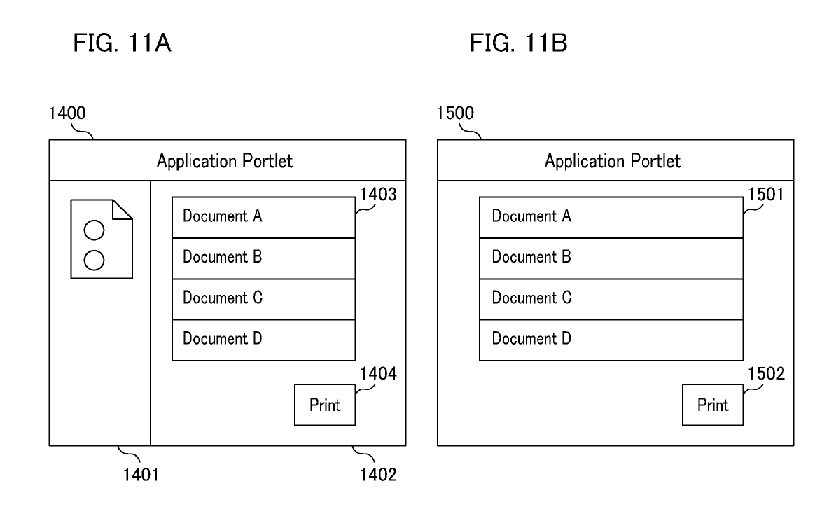

Hereinafter, preferred embodiments of the present invention will now be described with reference to the accompanying drawings. Note that the portal server as described below efficiently utilizes various applications that are dispersed within an enterprise, and thus collectively displays the applications as portlets on a single Web system. Also, the term “portlet” refers to a detachable application that is managed and displayed on a portal server. A user interface (hereinafter referred to as “UI”) best suited for printing is a UI for only displaying information required for printing, the details of which will be described below with reference to FIGS. 11A and 11B.

### First Embodiment

Hereinafter, a schematic explanation will be given of a first embodiment of the present invention. The portal system according to the present embodiment displays only a document that a user wishes to print using an image forming apparatus that accesses the system on an UI that is suited for printing. Each of documents that are uniformly managed in the portal system has a flag indicating whether or not a print job is in the “print-waiting” state, and an association is established for each document in terms of ensuring that each document is displayed by a given portlet depending on the type of document. Furthermore, association is established for each portlet in terms of ensuring that each document is displayed by a given image forming apparatus. When an access is made from an image forming apparatus, the UI that is suited for printing is provided. Depending on a document print request from an image forming apparatus, a portal server displays the name of a print target document or the like of the portlets associated with the image forming apparatus. Among the display-associated documents, each portlet only displays a document with a print-waiting flag being set in the UI that is suited for printing.

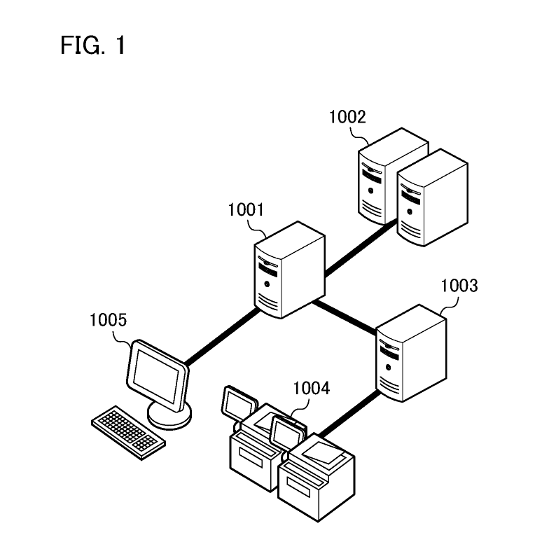

Next, an exemplary system configuration will be described. FIG. 1 is a diagram illustrating a system configuration according to one embodiment. A portal server 1001 includes a document management database (hereinafter, the term “database” is simply referred to as “DB”), and has a document management function. A plurality of application portlet servers (hereinafter simply referred to as a “portlet server”) 1002 shown in FIG. 1 executes the processing of the application portlets (hereinafter referred to as a “portlet”) to thereby provide these functions. A printer portlet server 1003 is a management device for managing the image forming apparatuses 1004 that form a group of image forming apparatuses. A client computer 1005 used by a user accesses the portal server 1001. Each apparatus is an information processing apparatus such as a computer or an image forming apparatus including a CPU (Central Processing Unit) and a storage section (RAM, ROM, HDD, and the like). Note that the procedure shown in the following flowchart is realized by interpreting and executing the information processing program, which is stored in the storage section of any one of the computers for use in the apparatuses 1001 to 1003, and 1005 or the storage section of the image forming apparatus 1004, by the CPU.

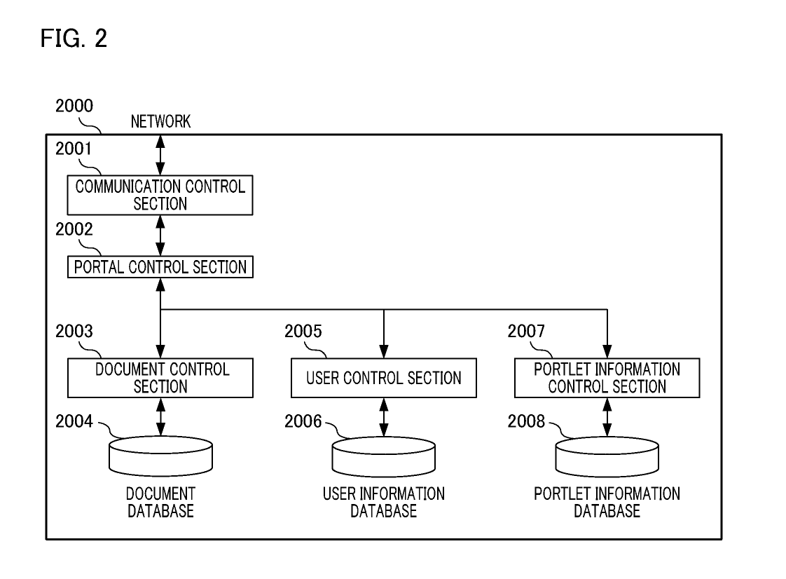

FIG. 2 is a block diagram illustrating an example of the configuration 2000 of the portal server 1001. A communication control section 2001 transmits/receives information among the portlet servers 1002, the printer portlet server 1003, and the client computer 1005 via a network in accordance with an instruction given by a portal control section 2002.

The portal control section 2002 controls a communication control section 2001, a document control section 2003, a user control section 2005, and a portlet information control section 2007, and controls processing in the portal server 1001. The document control section 2003 exchanges information with a document DB 2004 in accordance with an instruction given by the portal control section 2002 to perform document control such as document acquisition or document search. The document DB 2004 stores information relating to document such as document data, document attribute information, or the like, and provides the stored information in accordance with an instruction given by the document control section 2003.

The user control section 2005 exchanges information with a user information DB 2006 in accordance with an instruction given by the portal control section 2002, and controls first management information (user information) such as the settings or acquisition of a document list in which a print flag is set for each user. The user information DB 2006 stores user information, and provides the stored information in accordance with an instruction given by the user control section 2005. The user information includes information required for processing a document list, such as a user name, a document name and a document type that are associated with the user name, a print flag, and the like.

The portlet information control section 2007 exchanges information with a portlet information DB 2008 in accordance with an instruction given by the portal control section 2002. The portlet information control section 2007 controls information relating to the portlet (portlet information) such as acquisition of information indicating the type of document associated with the portlet. The portlet information DB 2008 stores portlet information such as the type of a document corresponding to a portlet or the like, and provides the stored information in accordance with an instruction given by the portlet information control section 2007.

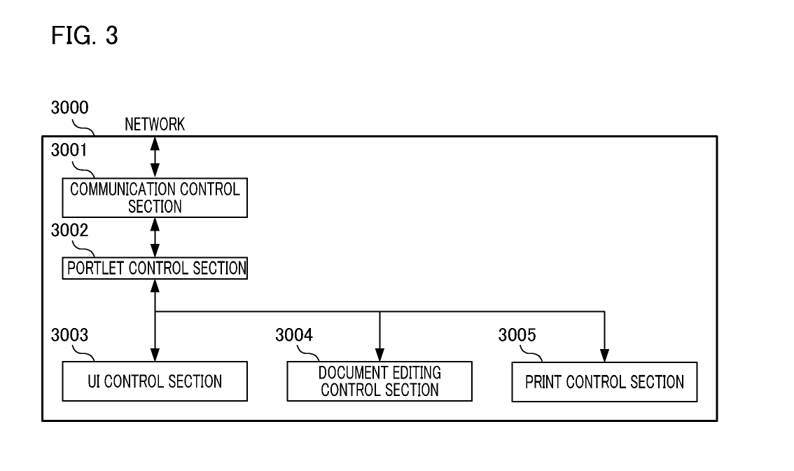

FIG. 3 is a block diagram illustrating an example of the configuration 3000 of the portlet server 1002. A communication control section 3001 transmits/receives information to/from the portal server 1001 via a network in accordance with an instruction given by a portlet control section 3002. The portlet control section 3002 controls a communication control section 3001, an UI control section 3003, a document editing control section 3004, and a print control section 3005, and controls processing in the portlet server 1002. The UI control section 3003 controls generation of a predetermined UI, an UI for printing or the like in accordance with an instruction given by the portlet control section 3002. The document editing control section 3004 controls a document editing corresponding to the function of an application portlet in accordance with an instruction given by the portlet control section 3002. For example, in a bookbinding application for printing, the document editing control section 3004 controls processing such as the generation and imposition of print preview screen data. The print control section 3005 controls document print processing such as generation of data that is printable by the image forming apparatus 1004 in accordance with an instruction given by the portlet control section 3002.

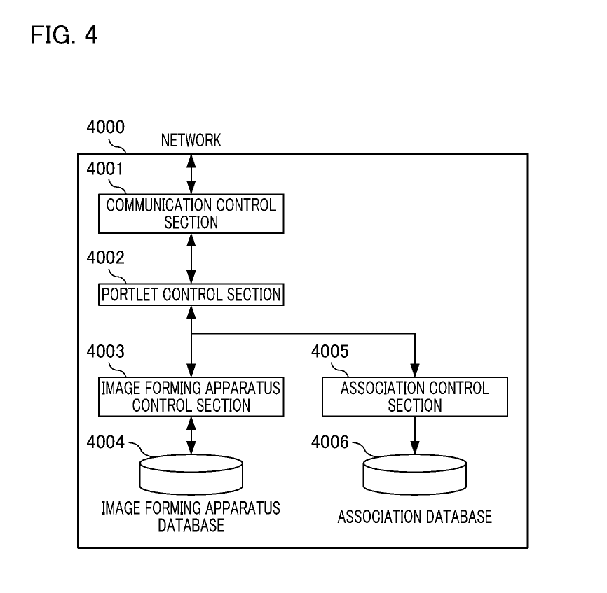

FIG. 4 is a block diagram illustrating an example of the configuration 4000 of the printer portlet server 1003. A communication control section 4001 transmits/receives information to/from the portal server 1001 via a network in accordance with an instruction given by a portlet control section 4002. The portlet control section 4002 controls a communication control section 4001, an image forming apparatus control section 4003, and an association control section 4005, and controls processing in the printer portlet server 1003. The image forming apparatus control section 4003 transmits/receives information to/from an image forming apparatus DB 4004 in accordance with an instruction given by the portlet control section 4002, and controls acquisition of information about the image forming apparatuses that can perform printing. The image forming apparatus DB 4004 stores information relating to the image forming apparatuses, such as a list of the image forming apparatuses that can perform printing, and provides the stored information in accordance with an instruction given by the image forming apparatus control section 4003. The association control section 4005 transmits/receives information to/from an association DB 4006 in accordance with an instruction given by the portlet control section 4002, and controls the settings of the image forming apparatus associated with an application portlet, and the acquisition of information about the apparatus. The association DB 4006 stores the association information about the application portlet and the image forming apparatus, and provides the stored information in accordance with an instruction given by the association control section 4005.

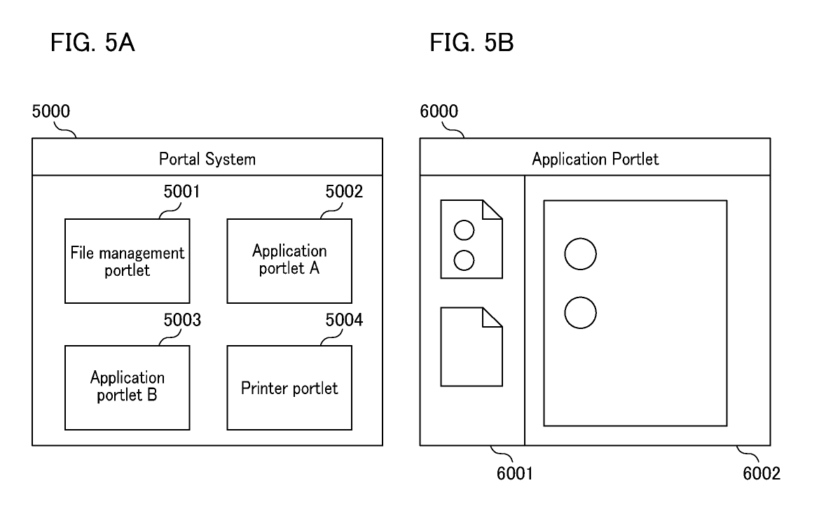

Next, a schematic explanation will be given of the portal system according to the present embodiment with reference to FIG. 5A. The main screen 5000 of the portal system shows an example of the UI (standard UI) screen to be displayed when an access is made from the client computer 1005 to the portal server 1001. Screen data is generated by the portal server 1001, and then is transmitted to the client computer 1005 for display. A user can perform various operations such as editing documents. The main screen 5000 of the portal system is configured by areas relating to several portlets. In the present embodiment, areas 5001 to 5004, i.e., a file management portlet, two application portlets, and a printer portlet, are shown.

The file management portlet (see the area 5001) is software that operates on the portal server 1001 and is accessible to information stored in the document DB 2004. An application portlet A (see the area 5002) and an application portlet B (see the area 5003) are software that operates on the portlet server 1002. The application portlet provides, for example, the editing function or the like for the documents stored in the document DB 2004. In an exemplary screen 6000 shown in FIG. 5B, thumbnail images are displayed on a thumbnail display area 6001 in each page of the documents. A content area 6002 displays the page that has been selected at the thumbnail display area 6001, and a user can perform operations such as editing or the like.

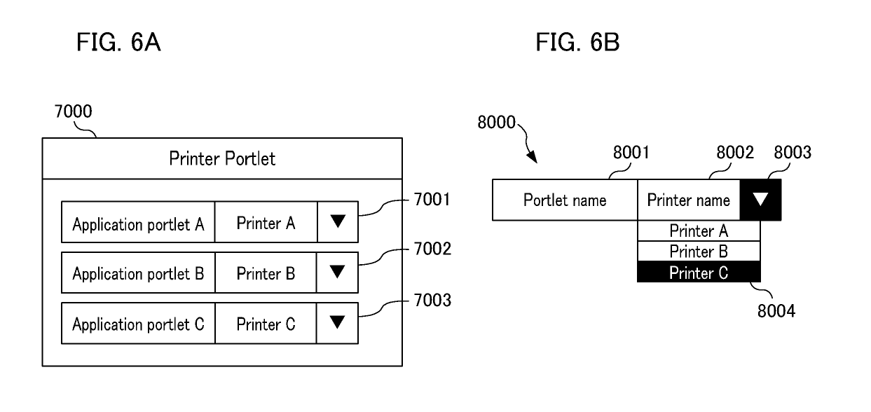

A printer portlet (see the area 5004) is software that operates on the printer portlet server 1003 and has a function of associating image forming apparatuses with portlets. FIG. 6A is a diagram illustrating an example of a list display about the association between portlets and image forming apparatuses. The areas 7001 to 7003 exemplify the association between application portlets and printers. FIG. 6B is a diagram illustrating display and selection operation of each area, and the area 8000 shown in the present embodiment is constituted by three sectional areas. A first area 8001 displays the name of an application portlet, and a second area 8002 displays the name of a printer associated with the application portlet. An instruction button 8003 is provided for displaying a candidate list 8004 of printers relating to an association operation. When displaying the candidate list 8004 is ordered by the operation of the instruction button 8003, the options of associatable printers are displayed on a pull down menu, so that a user can select a desired printer.

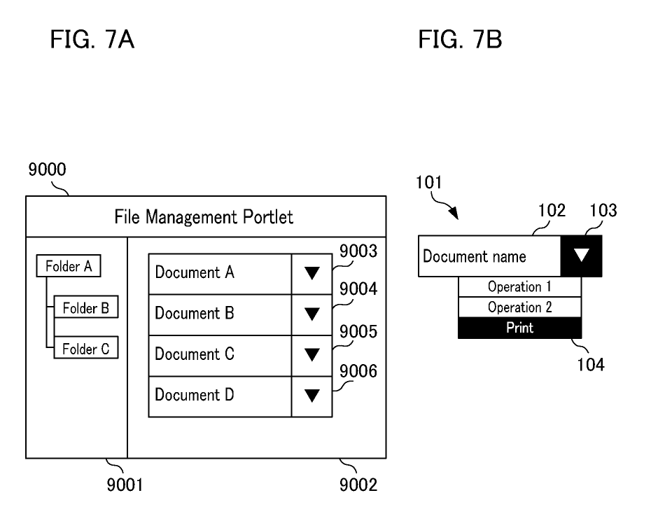

FIG. 7A is a diagram illustrating an example of a screen 9000 of a file management portlet. A tree view area 9001 shows a hierarchical structure of document data. A content area 9002 lists the documents in the folder selected by the tree view area 9001. The areas 9003 to 9006 exemplify the document names to be displayed on the content area 9002. Each area has the constitution shown in FIG. 7B. Specifically, an area 101 is constituted by an area 102 for displaying a document name, and an instruction button 103 for displaying a list of operations for documents. When a user operates the instruction button 103 to order displaying an operation list 104, operable options are displayed on the operation list 104 as a pull down menu.

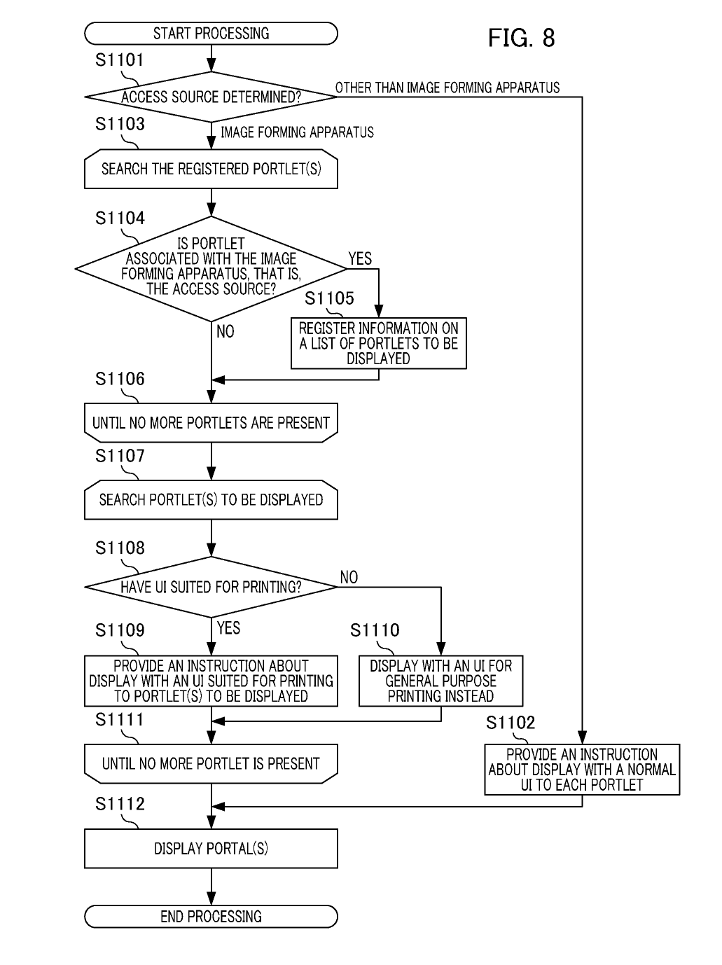

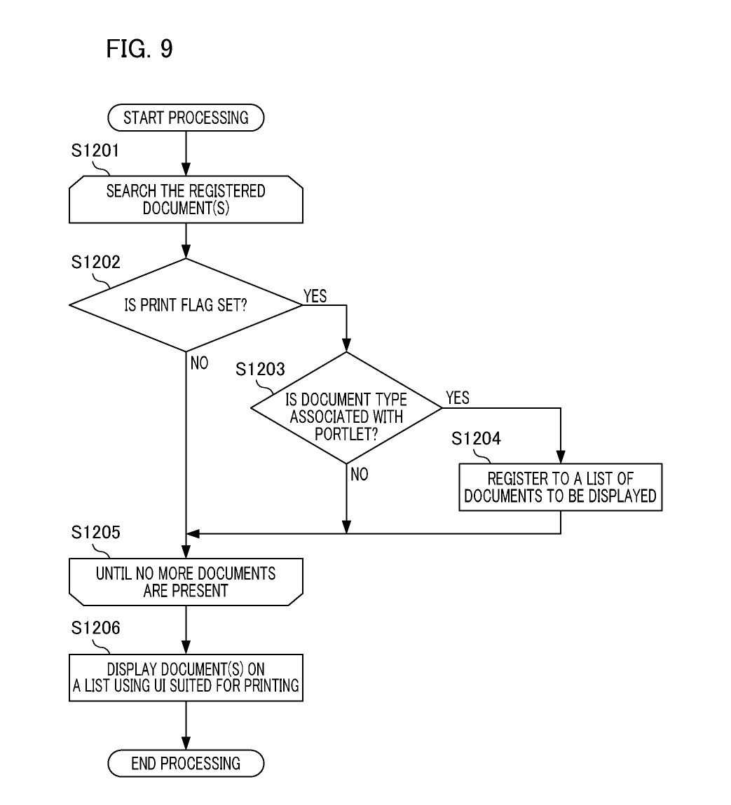

Next, the flow of processing of the present embodiment will be described in accordance with the flowcharts shown in FIGS. 8 and 9. First, a user accesses the portal server 1001 from the client computer 1005 to thereby start processing shown in FIG. 8. The portal server 1001 that has received an access request from the client computer 1005 performs display screen data generation processing in accordance with the flowchart shown in FIG. 8. In step S1101, the portal server 1001 determines an access source. The portal control section 2002 accesses the printer portlet server 1003 via a network to thereby acquire the IP (Internet Protocol) address of the image forming apparatus stored in the image forming apparatus DB 4004. The portal control section 2002 compares the acquired IP address with the IP address of the access source acquired from the request information for HTTP (Hyper Text Transfer Protocol). The portal control section 2002 determines whether or not the access source apparatus is an image forming apparatus. As a result, when the portal control section 2002 determines that the access source apparatus is an image forming apparatus such as a printer or the like, the process advances to step S1103. In contrast, when the portal control section 2002 determines that an access is made from other than an image forming apparatus (e.g., the client computer 1005), the process advances to step S1102. Here, the portal control section 2002 provides an instruction regarding UI screen display processing to each portlet server, and then the process advances to step S1112.

In step S1112, the portal control section 2002 controls the generation processing for data regarding to the main screen 5000 (see FIG. 5A) of the portal system, and transmits the data to the client computer 1005. The client computer 1005, which has received data for generating the main screen 5000, displays the main screen 5000 on a display section to provide it to a user. The user employs an application portlet (see the screen 6000 shown in FIG. 5B) to perform editing processing required for the documents stored in the document DB 2004. Then, the user employs a file management portlet (see the screen 9000 shown in FIG. 7A) to provide an instruction for printing the document of which editing has ended. In other words, a user selects the folder, which stores a print target document, using the tree view area 9001 to thereby select the print target document from the list of the documents displayed in the content area 9002. When a user pushes the instruction button 103 for the print target document, the operation list 104 is displayed. Hence, by selecting the “print” icon from the display items via a user operation, print instruction is issued.

In the portal server 1001, the communication control section 2001 receives a print instruction for a document and reports it to the portal control section 2002. The portal control section 2002 associates the print target document with its print flag and stores them in the user information DB 2006 via the user control section 2005. The value of the print flag represents the set state regarding the presence or absence of a print instruction for a target document. An example of the association information to be stored in the user information DB 2006 is shown in Table 1.

TABLE 1

| | DOCUMENT | DOCUMENT | PRINT |
|---|---|---|---|
| USER NAME | NAME | TYPE | FLAG |
| @@¥03445 | DOCUMENT A | TEXT | YES |
| @@¥03445 | DOCUMENT B | TEXT | YES |
| @@¥03445 | DOCUMENT C | TEXT | YES |
| @@¥03445 | DOCUMENT D | TEXT | YES |
| @@¥03445 | DOCUMENT E | IMAGE | YES |
| @@¥03445 | DOCUMENT F | TEXT | NO |
| @@¥12422 | DOCUMENT G | TEXT | YES |

The association information shown in the present embodiment is constituted by a user name, a document name, a document type, and a print flag. The example of the first row indicates that a person who is specified by the user name “@@¥03445” has made the settings of a print flag “yes” with respect to the document name “document A” with the document type “text”. Note that the present embodiment is not limited thereby, and a user name and a document name may also be ID information capable of providing unique identification.

The explanation of processing after step S1103 shown in FIG. 8 will be preceded by the explanation regarding the association between an application portlet and an image forming apparatus. It is required that a given image forming apparatus that prints the output data of each application portlet be set prior to execution of print processing in accordance with the user's operation instruction. The client computer 1005 provides the main screen 5000 of the portal system to a user. The user employs a printer portlet (see the screen 7000 shown in FIG. 6A) to establish the association between an application portlet and an image forming apparatus. A user selects the application portlet to which a user wishes to establish the association from the list shown in FIG. 6A. When the instruction button 8003 is pushed, the candidate list 8004 of the printers is displayed. A user selects an image forming apparatus, to which the user wishes to establish the association with the application portlet displayed on the area 8001, from the candidate list 8004.

The portlet control section 4002 provided in the printer portlet server 1003 receives an instruction about establishing an association with the application portlet. The control section stores the association information between an application portlet and an image forming apparatus in the association DB 4006 via the association control section 4005. An example of association information is shown in Table 2.

TABLE 2

| | APPLICATION | IMAGE FORMING |
|---|---|---|
| USER NAME | PORTLET NAME | APPARATUS NAME |
| @@¥03445 | APPLICATION PORTLET A | IMAGE FORMING |
| | | APPARATUS A |
| @@¥03445 | APPLICATION PORTLET B | IMAGE FORMING |
| | | APPARATUS B |
| @@¥12422 | APPLICATION PORTLET A | IMAGE FORMING |
| | | APPARATUS C |

The information shown in the present embodiment is constituted by a user name, an application portlet name, and an image forming apparatus name. The example of the first row indicates that a person who is specified by the user name “@@¥03445” has established the association between “the application portlet A” and “the image forming apparatus A”. Note that each name may be ID information capable of providing unique identification.

Next, extraction processing for the application portlet to be displayed will be described. A user who has completed print preparation accesses the portal server 1001 from the image forming apparatus 1004 via the printer portlet server 1003 to thereby provide an instruction about the output of print data according to a desired document. The portal server 1001 that has received an access request from the image forming apparatus 1004 determines the access source in step S1101 shown in FIG. 8 and detects that an access has been made from the image forming apparatus 1004. Then, the process advances to portlet search processing, i.e., iterative processing between steps S1103 and S1106. The portal control section 2002 accesses the printer portlet server 1003 to thereby acquire storage information (see Table 2) indicating the association between an application portlet and an image forming apparatus for each user stored in the association DB 4006. The portal control section 2002 searches the registered application portlet that is associated with the image forming apparatus, namely, the access source apparatus, in the setting information about the user who is being given access to the portal system. It is determined whether or not an application portlet is associated with the image forming apparatus, namely, the access source apparatus (S1104). When it is determined that such association is established, the process advances to step S1105, whereas when it is determined that such association is not established, the process advances to step S1106.

In step S1105, the portal control section 2002 registers information about the application portlet, which has determined that the association is established in step S1104, on a list and stores the information in a memory (not shown). Specifically, the application, which is associated with both the image forming apparatus, that is, the access source apparatus, and the user who has made a print request, is determined in step S1105. For example, when the association shown in Table 2 is established, it is assumed that the name of the user who is being given access to the portal server 1001 is “@@¥03445”, and the name of the image forming apparatus, that is, the access source apparatus, is the “image forming apparatus A”. In this case, the “application portlet A” associated with the “image forming apparatus A” is stored in a memory.

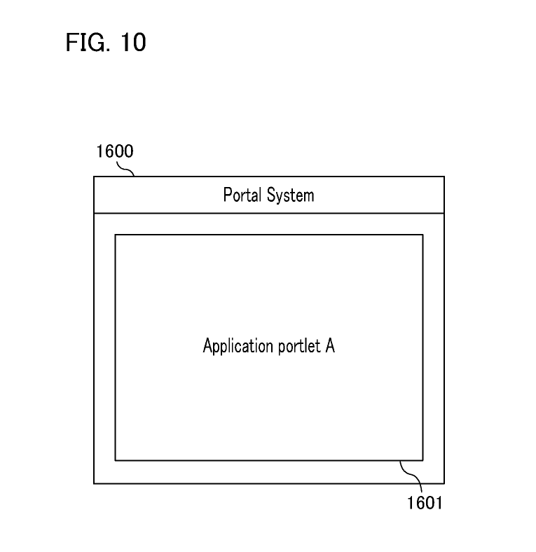

When the search for all of the registered application portlets is ended in step S1106, the process advances to search processing for the application portlet to be displayed, and iterative processing between steps S1107 and S1111 is executed. In step S1108, it is determined whether or not the portlet server 1002 has the UI that is best suited for printing, the details of which will be described in a second embodiment described below. Hereinafter, assuming that such an UI screen can be displayed, the process advances to step S1109. The portal control section 2002 provides an instruction about displaying the UI that is best suited for printing to each portlet server, and carries out control such that only the application portlet stored in the list in step S1105 is displayed on the main screen (see FIG. 10). Data for generating an UI screen suited for printing is transmitted to the image forming apparatus 1004.

FIG. 10 shows an example in which, when the association shown in Table 2 is established, a user who is being given access to the portal server 1001 is “@@¥03445”, and the “application portlet A” is displayed as the main screen 1600 on the “image forming apparatus A” that is an access source. In contrast to the main screen 5000 to be displayed when an access is made from the client computer 1005 to the portal server 1001, only the “application portlet A” extracted in step S1105 is displayed at an area 1601. Note that processing in step S1100 shown in FIG. 8 will be described in the second embodiment described below. When the search for the application portlet to be displayed is ended in step S1111, iterative processing is ended, and a series of processes is ended through step S1112.

Next, generation processing for a screen according to the UI that is best suited for printing will be described with reference to the flowchart show in FIG. 9. The portlet server 1002 receives an instruction from the portal server 1001 to thereby generate data for an UI screen. Note that a specific example given in the middle of the following description indicates the case where an access is made from the image forming apparatus A.

Search processing for searching the registered document is executed as iterative processing between steps S1201 and S1205. In step S1202, the portlet server 1002 acquires the necessary information from the user information DB 2006 provided with the portal server 1001. This information is information indicating the list of documents for which the print flags are set for each user. Of the list of documents, the portlet control section 3002 acquires data indicating the list of documents for which the print flags are set by a user who is being given access to the portal server 1001. For example, when the association shown in Table 1 described above is established and if the name of the accessing user is “@@¥03445”, the six documents from “document A” to “document F”, which are set under the name of the user, are searched. Next, from the six documents, five documents from “document A” to “document E”, for which the print flags are set, are searched. In step S1202, the portlet server 1002 determines whether or not the print flag is set to each document. When the flag value indicates the setting of “Yes”, the process advances to step S1203, whereas when the flag value indicates the setting of “No”, the process advances to step S1205.

In step S1203, the portlet server 1002 acquires second management information, which is stored in the portlet information DB 2008, from the portal server 1001. This information includes the information about the document type (type such as text, image and the like) which is associated with an application portlet. An example of management information stored in the portlet information DB 2008 is shown in Table 3.

TABLE 3

| APPLICATION PORTLET NAME | DOCUMENT TYPE |
|---|---|
| APPLICATION PORTLET A | TEXT |
| APPLICATION PORTLET B | IMAGE |
| APPLICATION PORTLET C | DOCUMENT |

As described above, the “application portlet A” is associated with the image forming apparatus A that has made an access. Hence, a reference is made to the document type of the “application portlet A”. Table 3 shows that the document type “text” is associated with the “application portlet A”. Based on the association information, narrowing down the document type from the list of documents acquired in step S1202 is further performed by filtering processing. In other words, it is determined whether or not the document type of the document to be searched matches the type of the document associated with an application portlet. When it is determined that the document types are matched to each other in step S1203, the process advances to step S1204, and data indicating the applicable document is registered to a list for display. For example, among the five documents (documents A to E), which has been obtained by the search, shown in Table 1, four documents from the “document A” to the “document D” have a “text” document type, and data indicating these documents is registered to a list and is stored in a memory.

When it is determined that the document types do not match each other after step S1204 or in step S1203, the process advances to step S1205. Here, when the search for all of the target documents is ended, the process advances to step S1206. The portlet control section 3002 provided in the portlet server 1002 generates data for composing the list of the finally acquired documents with a printing UI screen generated by the UI control section 3003 and displaying the resulting screen. A screen 1400 shown in FIG. 11A is an example of a print operation screen, and is displayed on the display section provided in the image forming apparatus A, that is, the access source, in accordance with the aforementioned example. In contrast to the case of the screen 6000 shown in FIG. 5B that is displayed when an access is made from the client computer 1005, the screen 1400 only displays the information necessary to execute printing. The screen 1400 is configured by a thumbnail display area 1401 and a content area 1402, and the thumbnail of the document selected at the content area 1402 is displayed on the thumbnail display area 1401. An area 1403 that indicates a list of the print target documents and an instruction button 1404 that performs printing with respect to a document selected by the area 1403 are displayed on the content area 1402. The document names listed on the area 1403 are the names of the documents that have been registered to a list in step S1204. In other words, the documents A to D shown in the present embodiment are the documents that are associated with the user name “@@¥03445” and satisfy the following search conditions:

The setting of the print flag value indicates “Yes” in Table 1.

The document type “text” shown in Table 3 that corresponds to the “application portlet A” associated with the “image forming apparatus A” is present in Table 2.

Data of the UI screen, which is suited for printing, that has been generated by the portlet server 1002 is transmitted to the portal server 1001. The portal server 1001 transmits data for generating the UI screen 1400 (see FIG. 11A) that is suited for printing in conjunction with data for generating the main screen 1600 (see FIG. 10) of the portal system to the image forming apparatus 1004. The image forming apparatus 1004 receives data via the printer portlet server 1003, and displays the UI screen that is suited for printing.

According to the first embodiment, the display section provided in the image forming apparatus only displays the application portlets associated with the image forming apparatus in the main screen of the portal system, whereby a user can provide an instruction to print a desired document while viewing the UI screen that is suited for printing. In other words, among document data relating to applications associated with the image forming apparatus, information relating to document data, to which a user has provided an instruction to perform printing, is displayed on the image forming apparatus. On the other hand, among document data relating to applications associated with the image forming apparatus, information relating to document data, to which a user has not provided an instruction to perform printing, is not displayed on the image forming apparatus. Therefore, a user can readily select a desired document for printing, resulting in a reduction in the operational load for printing.

### Second Embodiment

Next, a second embodiment of the present invention will be described. In the portal system according to the second embodiment, when a portlet server does not have an UI that is suited for printing, the portal server displays an operation screen using a general purpose UI that is suited for printing. The configurations of the system, each server, and each software are the same as those in the first embodiment, and thus the differences will be described in the following explanation.

In FIG. 8, search processing for portlets to be displayed is repeatedly executed between steps S1107 and S1111. In the first embodiment, the process advances to step S1109 without taking the condition judgment shown in step S1108 into consideration. In the second embodiment, in S1108, the portal control section 2002 provided in the portal server 1001 confirms the presence or absence of an UI that is suited for printing with respect to the UI control section 3003 via the portlet server 1002. In other words, it is determined whether or not the portlet server 1002 has an UI that is suited for printing. When the portlet server 1002 does not have the UI, the process advances to step S1110. Here, the portal server 1001 substitutes an UI that is suited for general purpose printing (hereinafter referred to as “UI for general purpose printing”).

When the portlet server 1002 does not maintain an UI that is best suited for printing, the portal server 1001 generates screen data according to an UI for general purpose printing. Although the flow of processing is basically the same as the flowchart shown in FIG. 9, in step S1203, the portal server 1001 acquires information about the document types, which are stored in the portlet information DB 2008, via the portlet information control section 2007. This information is information about the document types associated with the target application portlets that perform display instead.

In step S1206, information such as a document name or the like is displayed using the UI for general purpose printing. The portal control section 2002 provided in the portal server 1001 performs display control of the application portlets using the UI for general purpose printing. In other words, the portal control section 2002 maintains data for generating an operation screen for a UI for general purpose printing, and transmits data to the image forming apparatus 1004 via the printer portlet server 1003. A screen 1500 shown in FIG. 11B is an example of a print operation screen generated based on screen data for the UI for general purpose printing. In contrast to the UI screen 1400 to be displayed on the image forming apparatus 1004 based on the data generated by the portlet server 1002, the screen 1500 only displays information independent of the application and document type. For example, the screen 1500 only displays a print target document name list 1501, and an instruction button 1502 that performs printing with respect to a document selected by a user using the document name list. The portal server 1001 transmits data for generating the screen 1500 for a UI for general purpose printing, which has been generated instead of the portlet server 1002, in conjunction with data for generating the main screen 1600 of the portal system to the image forming apparatus 1004. The image forming apparatus 1004 receives data via the printer portlet server 1003, and displays the screen of the UI for general purpose printing.

According to the second embodiment, even when a user prints a file associated with an application portlet which does not have an UI that is suited for printing, the user can provide an instruction to print a desired document while viewing the display screen of the image forming apparatus 1004 by the use of the UI for general purpose printing. Therefore, a user can readily select a desired document for printing without tracing a folder hierarchy, resulting in a reduction in the operational load for printing.

### Other Embodiment

While in the aforementioned embodiments, a portal server and a printer portlet server are separated from each other, the present invention is not limited thereto. A document print instruction may also be provided from an image forming apparatus to an apparatus integrally including both functions.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-065944 filed Mar. 23, 2010, which is hereby incorporated by reference herein in its entirety.

What is claimed is:

1. An information processing apparatus that transmits data for generating a print operation screen according to an application to an image forming apparatus in accordance with a document print instruction given by the image forming apparatus, the information processing apparatus comprising:
a determination unit configured to determine an application associated with the image forming apparatus that has given a document print instruction and a user who has given the print instruction;
a specification unit configured to specify document data to which printing has been ordered by the user in document data associated with the application determined by the determination unit; and
a control unit configured to control the transmission of data for generating a print operation screen according to the application determined by the determination unit to the image forming apparatus such that information relating to document data specified by the specification unit is displayed and information relating to document data not specified by the specification unit is not displayed.

2. The information processing apparatus according to claim 1, wherein the control unit acquires association information, which associates the image forming apparatus with the application, from a management device provided in the image forming apparatus.

3. The information processing apparatus according to claim 2, wherein, when the application associated with the image forming apparatus is searched, the control unit acquires data for generating the print operation screen from an apparatus that performs processing for the application and transmits it to the image forming apparatus to thereby cause the image forming apparatus to display a print operation screen corresponding to the application.

4. The information processing apparatus according to claim 3, wherein the control unit determines whether or not an apparatus that performs processing for the application has data for generating a print operation screen, and when the apparatus does not have data for generating the print operation screen, the control unit transmits data for generating a predetermined print operation screen to the image forming apparatus.

5. An information processing method for transmitting data for generating a print operation screen according to an application to an image forming apparatus in accordance with a document print instruction given by the image forming apparatus, the information processing method comprising the steps of:
determining, in a determination step, an application associated with the image forming apparatus that has given a document print instruction and a user who has given the print instruction;
specifying, in a specification step, document data to which printing has been ordered by the user in document data associated with the application determined by the determination step; and
controlling, in a control step, the transmission of data for generating a print operation screen according to the application determined by the determination step to the image forming apparatus such that information relating to document data specified by the specification step is displayed and information relating to document data not specified by the specification step is not displayed.

6. A storage medium storing a computer-readable program for causing a computer to execute a method for transmitting data for generating a print operation screen according to an application to an image forming apparatus in accordance with a document print instruction given by the image forming apparatus,
wherein the program causes the computer to carry out the steps of:
determining, in a determination step, an application associated with the image forming apparatus that has given a document print instruction and a user who has given the print instruction;
specifying, in a specification step, document data to which printing has been ordered by the user in document data associated with the application determined by the determination step; and
controlling, in a control step, the transmission of data for generating a print operation screen according to the application determined by the determination step to the image forming apparatus such that information relating to document data specified by the specification step is displayed and information relating to document data not specified by the specification step is not displayed.
